(19) United States
(12) Patent Application Publication
(10) Pub. No.: US 2025/0299601 A1
(43) Pub. Date: Sep. 25, 2025

(54) METHOD, APPARATUS, PROGRAM, AND SYSTEM FOR COLLECTING SIGN LANGUAGE VIDEO INFORMATION, AND METHOD, APPARATUS, PROGRAM, AND SYSTEM FOR GENERATING SIGN LANGUAGE INFORMATION

(71) Applicant: RISO KAGAKU CORPORATION, Tokyo (JP)

(72) Inventors: Akiko NOZAWA, Tokyo (JP); Akira HASHIMOTO, Tokyo (JP)

(73) Assignee: RISO KAGAKU CORPORATION, Tokyo (JP)

(21) Appl. No.: 19/078,860

(22) Filed: Mar. 13, 2025

(30) Foreign Application Priority Data
Mar. 22, 2024 (JP) 2024-046322
Mar. 22, 2024 (JP) 2024-046323
Mar. 22, 2024 (JP) 2024-046324

(51) Int. Cl. G09B 21/00; G06V 20/40; G06V 40/20; G09B 5/02

(52) U.S. Cl. CPC G09B 21/009; G06V 20/46; G06V 40/28; G09B 5/02

(57) ABSTRACT

A sign language video information collecting apparatus includes a registration word candidate determining unit that determines registration candidate words for which a sign language registrant is requested to register sign language and outputs the determined registration candidate words to a terminal device of the sign language registrant, a sign language video information obtaining unit that obtains sign language video information corresponding to a registration candidate word which is output from the terminal device of the sign language registrant in response to input of the registration candidate words, and a sign language video information storage unit 14 that stores the sign language video information corresponding to the registration candidate word correlated with the registration candidate word.

### CROSS-REFERENCE TO RELATED APPLICATIONS

The present application claims priority under 35 U.S.C. § 119 to Japanese Patent Application No. 2024-046322, filed on Mar. 22, 2024, Japanese Patent Application No. 2024-046323, filed on Mar. 22, 2024 and Japanese Patent Application No. 2024-046324, filed on Mar. 22, 2024. The above applications are hereby expressly incorporated by reference, in these entireties, into the present application.

### BACKGROUND OF THE INVENTION

### 1. Field of the Invention

The present disclosure relates to a sign language video information collecting apparatus, a sign language video information collecting method, a sign language video information collecting program, a sign language video information collecting system, as well as a sign language video information generating apparatus, a sign language video information generating method, a sign language video information generating program, and a sign language video information generating system.

### 2. Description of the Related Art

Conventionally, a system that recognizes sign language movements from video data captured in sign language and displays them as character data has been proposed (refer to “SureTalk”, Softbank Corporation, Internet<URL: https://www.suretalk.mb.softbank.jp/function/>).

In order to construct a linguistic analysis and recognition system for sign language, etc., it is necessary to collect a large scale of sign language movement data. Japanese Unexamined Patent Publication No. 2020-126144 proposes a method for collecting sign language video data by using a terminal device to capture images of sign language movements.

### SUMMARY OF THE INVENTION

However, since there are differences in the movements of sign language depending on individuals, it is desirable to collect sign language video data for as many words from as many people as possible in an even manner. Since the sign language to be registered is selected based on the free will of a user in Japanese Unexamined Patent Publication No. 2020-126144, it is not possible to collect sign language video data from as many people as possible without bias. Unbiased means that there are no differences in the amount of sign language video data collected for each word according to various personal attributes.

The present disclosure has been developed in view of the foregoing circumstances. The present disclosure provides a sign language video information collection apparatus, a sign language video information collecting method, a sign language video information collecting program, a sign language video information collecting system, as well as a sign language video information generating apparatus, a sign language video information generating method, a sign language video information generating program, and a sign language video information generating system which are capable of collecting sign language video data from many people in an even and unbiased manner.

The sign language video information collecting apparatus of the present disclosure is equipped with a registration candidate word determining unit that determines registration candidate words for which a sign language registrant is requested to register sign language and outputs the determined registration candidate words to a terminal device of the sign language registrant, a sign language video information obtaining unit that obtains sign language video information corresponding to the registration candidate words output from the terminal device of the sign language registrant in response to input of the registration candidate words, and a sign language video information storage unit that stores sign language video information corresponding to the registration candidate words which are obtained by the sign language video information obtaining unit correlated with the registration candidate words.

According to the sign language video information collecting apparatus of the present disclosure, registration candidate words to be requested for a sign language registrant to register are determined, and the determined registration candidate words are output to the terminal device of the sign language registrant. That is, the sign language video information collecting apparatus, not the sign language registrant, determines the registration candidate words. Then, sign language video information corresponding to the registration candidate words which are output from the terminal device of the sign language registrant is obtained in response to the input of the registration candidate words, and the obtained sign language video information is stored. Therefore, collection of sign language video data from many people in an even and unbiased manner is enabled.

### BRIEF DESCRIPTION OF THE DRAWINGS

FIG. 1 is a block diagram that illustrates the schematic configuration of a sign language video information collecting system according to a first embodiment of the present disclosure.

FIG. 2A is a collection of diagrams that illustrate an example of a registrations count per attribute table and an example of a registration count per registrant table.

FIG. 2B is a collection of diagrams that illustrate an example of a registration count per registrant table.

FIG. 3 is a sequence diagram for explaining the flow of processes performed by the sign language video information collecting system of the first embodiment.

FIG. 4 is a sequence diagram for explaining the flow of processes the sign language video information collecting system of the first embodiment.

FIG. 5 is a diagram that illustrates an example of display of a list of registration candidate words for registration

FIG. 6 is a diagram that illustrates an example of display of model sign language video data.

FIG. 7 is a block diagram that illustrates the schematic configuration of a sign language video information collecting system according to a second embodiment of the present disclosure.

FIG. 8 is a diagram that illustrates an example of a user information table.

FIG. 9 is a diagram that illustrates an example of a registration word information table.

FIG. 10 is a flow chart for explaining an example of a method for determining registration candidate words.

FIG. 11 is a flow chart for explaining an example of a method for determining registration candidate words.

FIG. 12 is a diagram that illustrates an example of a list of registration words before and after sorting based on a registration word range.

FIG. 13 is a schematic diagram that illustrates the relationship among a range of all registration words, a range of insufficient registration words, a range of registration words belonging to user interest information, and a range of registration words for priority attribute information.

FIG. 14 is diagram that illustrates an example of a category relevance table.

FIG. 15 is a sequence diagram for explaining the flow of processes performed by the sign language video information collecting system of the second embodiment.

FIG. 16 is a sequence diagram for explaining the flow of processes performed by of the sign language video information collecting system of the second embodiment.

FIG. 17 is a block diagram that illustrates the schematic configuration of a sign language video information collecting system of a third embodiment of the present disclosure.

FIG. 18 is a diagram that illustrates a specific example of a table of the number of registrations per registrant.

FIG. 19 is a sequence diagram that illustrates the flow of processes performed by the sign language video information collecting system of the third embodiment.

FIG. 20 is a sequence diagram for explaining the flow of processes performed by the sign language video information collecting system of the third embodiment.

### DETAILED DESCRIPTION OF THE EMBODIMENTS

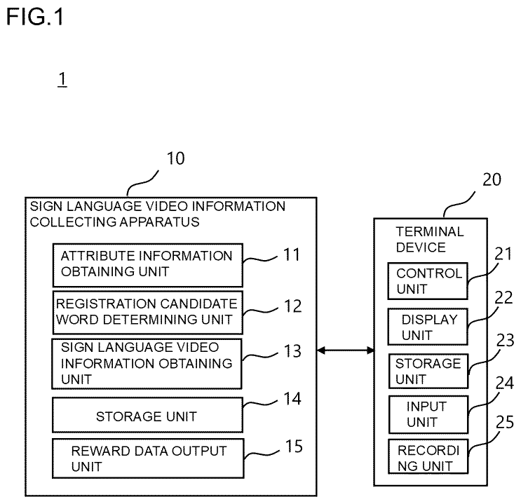

A sign language video information collecting system 1 that employs a sign language video information collecting apparatus according to a first embodiment will be described in detail with reference to the attached drawings. FIG. 1 is a block diagram that illustrates the schematic structure of the sign language video information collecting system 1.

The sign language video information collecting system 1 is a system for collecting video data of sign language. Specifically, the sign language video information collecting system 1 is a system that collects sign language video information of various sign language users of different ages, genders, and physiques evenly, and also enables sign language users to register their own sign language video information while enjoying themselves.

As illustrated in FIG. 1, the sign language video information collecting system 1 of the present embodiment has a sign language video information collecting apparatus 10 and a terminal device 20 of a sign language registrant.

The sign language video information collecting apparatus 10 and the terminal device 20 of sign language registrants are connected via communication lines such as Internet lines or LAN (Local Area Network) lines, and are configured to exchange various types of information with each other. Although only one terminal device 20 of a sign language registrant is illustrated in FIG. 1, in reality, many terminal devices 20 of sign language registrants are connected to the sign language video information collecting apparatus 10, and each of the terminal devices 20 of sign language registrants registers sign language video information in the sign language video information collecting apparatus 10.

The following is a more detailed description of each component that constitutes the sign language video information collecting system 1.

As illustrated in FIG. 1, the sign language video information collecting apparatus 10 is equipped with an attribute information obtaining unit 11, a registration candidate word determining unit 12, a sign language video information obtaining unit 13, a storage unit 14, and a reward data output unit 15.

The attribute information obtaining unit 11 obtains attribute information of a sign language registrant. The attribute information of a sign language registrant is information related to the sign language registrant, and includes at least one of the following: identification information unique to the sign language registrant, gender, age, hometown, occupational information (including information of students) the purpose of learning sign language, physique information, and sign language speed information, for example. Differences in the attribute information will result in differences in sign language movements. For example, sign language movement differs from individual to individual, and sign language movement differs depending on gender and age. Also, like dialects, sign language has regional characteristics, and the manner in which sign language movements are performed differs depending on the region. Sign language use also differs depending on the occupation of the person who has registered the sign language.

Physique information also includes height and weight, for example. Physique also results in differences in sign language movements. The sign language speed information is information regarding the speed of the sign language movements. In the present embodiment, the sign language registrant uses the terminal device 20 to set and input information regarding a self-assessed speed of sign language movements. For example, the sign language speed information is set and input by the sign language registrant selecting one of the three levels “fast”, “normal”, and “slow”.

The registration candidate word determining unit 12 determines registration candidate words for which a sign language registrant is requested to register sign language based on the attribute information of the sign language registrant. Then, the registration candidate word determining unit 12 outputs the determined registration candidate words to the terminal device 20 of the sign language registrant.

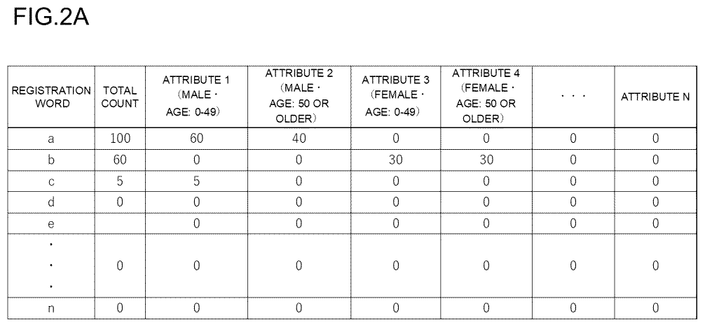

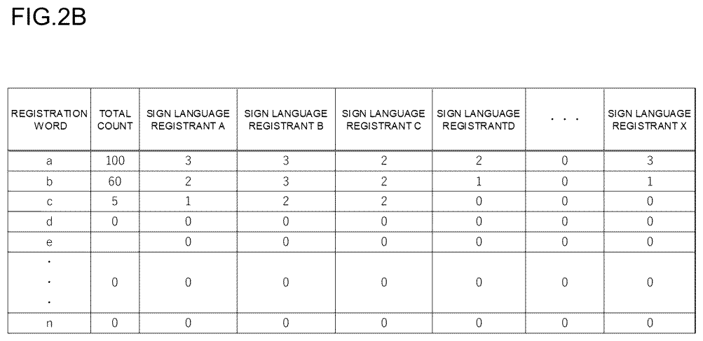

The method of determining the registration candidate words in the registration candidate word determining unit 12 will be described in detail below. The word candidate determining unit 12 has a registration count table per attribute that manages the number of registrations for each attribute information of a given registration word. FIG. 2A illustrates an example of the table. The registration count table per attribute table illustrated in FIG. 2A shows the number of registrations for each registration word a-n for each of different attributes 1-N.

Specifically, the number of registrations for a registration word a by sign language registrants belonging to attribute 1 (male, 0-49 years old) is 60, the number of registrations for the registration word a by sign language registrants belonging to attribute 2 (male, 50 years old or older) is 40, and the number of registrations for the registration word a by registrants belonging to other attributes 3 to N is zero, for example. The total number of registrations of the registration word a is 100.

In addition, the number of registrations for a registration word b by sign language registrants belonging to attribute 3 (female, 0-49 years old) is 30, the number of registrations for the registration word b by sign language registrants belonging to attribute 4 (female, 50 years old or older) is 30, and the number of registrations for the registeredregistration word b by registrants belonging to other attributes 1, 2, 5 to Nis zero, for example. The total number of registrations for the registration word b is 60.

That is, in the case of the registration count per attribute table illustrated in FIG. 2A, for the registration word a, the number of registrations for sign language registrants belonging to attributes 3 to N is insufficient, and for the registration word b, the number of registrations for sign language registrants belonging to attributes 1, 2, and attributes 5 to Nis insufficient. For registration words d through n, the number of registrations for all attributes is zero, indicating that the number of registrations is insufficient for all attributes. In the registration count per attribute table illustrated in FIG. 2A, attributes 1 to N are classified for each combination of age and gender. However, the present disclosure is not limited to such a configuration, and attributes 1 to N may also be classified by considering combinations of other items of attribute information described above.

In addition, the registration candidate word determining unit 12 has a registration count per registrant table that manages the number of registrations for each registrant of a given sign language for a given registration word. FIG. 2B illustrates an example of the table. In the table illustrated in FIG. 2B, the number of registrations for each registrant is shown for each of registration words a through n for different sign language registrants.

Specifically, for sign language registrant A, the number of registrations for the registration word a is 3, the number of registrations for the registration word b is 2, the number of registrations for the registration word c is 1, and the number of registrations for registration words d through n is zero, for example. This means that sign language registrant A has already registered the registration words a through c, but has not yet registered the registration words d through n.

The registration count per attribute table and the registration count per registrant table are updated whenever sign language video information for a newly registration word is registered.

Then, the registration candidate word determining unit 12 determines the registration candidate words for which a sign language registrant is requested to register sign language using the registration count per attribute table and the registration count per registrant table described above. Specifically, if the attribute information of the sign language registrant obtained by the attribute information obtaining unit 11 is attribute 1, the number of registration words a through n for attribute 1 illustrated in FIG. 2A is referenced to determine the registration words whose number of registration words is equal to or less than a predetermined threshold as registration candidate words, for example. In the case of the registration count per attribute table illustrated in FIG. 2A, for example, the number of registrations for registration words b and d through n is zero for attribute 1. Therefore, the registration words b and d through n are determined as registration candidate words.

In addition, the registration candidate word determining unit 12 identifies sign language registrants based on the identification information included in the attribute information of the sign language registrants obtained by the attribute information obtaining unit 11. Then, the registration candidate word determining unit 12 checks the number of registration words for each of the identified sign language registrants by referring to the registration count per registrant table illustrated in FIG. 2B, and determines the registration words having a registration count equal to or less than a predetermined threshold as registration candidate words. In the case that the identified sign language registrant is sign language registrant A, for example, the number of registrations for registration words d through n is zero. Therefore, the registration words d through n are determined as registration candidate words.

The registration candidate word determining unit 12 of the present embodiment determines final registration candidate words by adding the registration candidate words determined employing the registration count per attribute table and the registration candidate words determined using the registration count per registrant table.

In the case that the number of registration candidate words which are finally determined is greater than a preset threshold for the number of candidates to be displayed on the terminal device 20, priority may be given to the registration candidate words which are determined using the registration count per attribute table, and the number of such candidates may be reduced to the threshold for the number of candidates to be displayed. In the case that the number of registration candidate words determined using the registration count per attribute table is greater than the threshold of the number of candidates to be displayed above, priority may be given to words with lower numbers of registrations, and the number may be reduced to the threshold value. In the case that the number of registration candidate words is less than the preset threshold for the number of candidates to be displayed, the number may be increased up to the threshold value, giving priority to words with the smallest total number of data.

Then, the registration candidate word determining unit 12 outputs the finally determined registration candidate word which are determined in the manner described above to the terminal device 20 of the sign language registrant.

The sign language video information obtaining unit 13 obtains sign language video information corresponding to registration candidate words output from the terminal device 20 of the sign language registrant in response to the input of the registration candidate words. In the present embodiment, the sign language registrant demonstrates the sign language movements corresponding to the registration candidate word using the terminal device 20 and records the demonstration. The terminal device 20 extracts the feature points (or it can be called a landmarks) of the sign language movements from video data of the recorded sign language movements, and outputs information of the feature points as sign language video information to the sign language video information collecting apparatus 10. The sign language video information obtaining unit 13 then obtains the sign language video information which is output from the terminal device 20 in the manner described above.

The storage unit 14 stores sign language video information corresponding to the registration candidate words obtained by the sign language video information obtaining unit 13 by associating them with the registration candidate words. At this time, the number of registrations in the registration count per attribute table and the number of registrations in the registration count per registrant table are updated based on the stored registration candidate words and the attribute information of the sign language registrant. The storage unit 14 of the present embodiment corresponds to the sign language video information storage unit of the present disclosure.

When the reward data output unit 15 obtains sign language video information output from the terminal device 20 of the sign language registrant, it outputs reward data to the terminal device 20 of the sign language registrant. In the present embodiment, information regarding pet snacks used in a pet raising game which is launched on the terminal device 20 of the sign language registrant is output as the reward data, the details of which will be explained later.

The sign language video information collecting apparatus 10 is equipped with a CPU (Central Processing Unit), a semiconductor memory such as a ROM (Read Only Memory) and a RAM (Random Access Memory), storage such as a hard disk, a communication I/F (interface), etc.

An embodiment of the sign language video information collection program of the present disclosure is installed in the storage of the sign language video information collecting apparatus 10. When this sign language video information collection program is launched by the CPU, the functions of the components of the sign language video information collecting apparatus 10 described above are executed.

In the present embodiment, the functions of each component are performed by the CPU executing the sign language video information collection program, but some or all of the functions performed by the sign language video information collection program may be performed by hardware such as an ASIC (Application Specific Integrated Circuit), an FPGA (Field Programmable Gate Array), or other electrical circuits.

Next, the terminal device 20 of the sign language registrant will be described.

The terminal device 20 of the sign language registrant is used by the sign language registrant as described above, and is constituted by a mobile terminal such as a tablet terminal or a smartphone, for example. However, the terminal device 20 of the sign language registrant may also be constituted by a personal computer.

The terminal device 20 has a control unit 21, a display unit 22, a storage unit 23, an input unit 24, and a recording unit 25, as illustrated in FIG. 1. A sign language learning application is installed in the storage unit 23 of the terminal device 20.

The control unit 21 controls the entirety of the terminal device 20. Particularly, the control unit 21 performs functions such as displaying and receiving selection of registration candidate words, capturing sign language videos, and outputting sign language video information by launching a sign language learning application which is installed in the storage unit 23.

In addition to the function for learning sign language, the sign language learning application has a pet raising game function. The pet raising game is a game in which a user raises a pet while giving it snacks.

In addition, the control unit 21 also applies a feature point extraction process that extracts feature points of signs to the sign language video data captured by the recording unit 25. For example, the positions of joints and fingertips related to sign language movements are extracted as feature points. In addition to hand movements, feature points may also be extracted for facial movements, facial expressions, and movements involving the arms and body. An existing image process may be employed as the feature point extraction process, or a machine learning model in which feature points are machine learned in advance may be employed to extract the feature points.

Further, when extracting the feature points, it is possible to collect more accurate data by performing a correction process or a normalization process with respect to coordinates that take the vertical and horizontal position, orientation, size, etc. of the sign language registrant that may differ depending on the positional relationship between the sign language registrant and the recording unit 25 into consideration.

The display unit 22 displays a list of registration candidate words and a model sign language video data for a given registration candidate word.

The storage unit 23 stores the sign language learning application as described above, as well as model sign language video data. The storage 23 stores a great number of registration words (registration candidate words) and sign language video data that displays the registration words correlated with each other.

The input unit 24 accepts various setting inputs by the sign language registrant.

The recording unit 25 has a CMOS (Complementary Metal Oxide Semiconductor) camera or a CCD (Charged Coupled Device) camera, an imaging optical system, etc., to record the sign language movements of the sign language registrant. The sign language video data captured by the recording unit 25 is stored in the storage unit 23, and then the feature point extraction process is performed by the control section 21.

The sign language learning application may be installed in the storage 23 as in the present embodiment, or may be an application which is provided via a web browser.

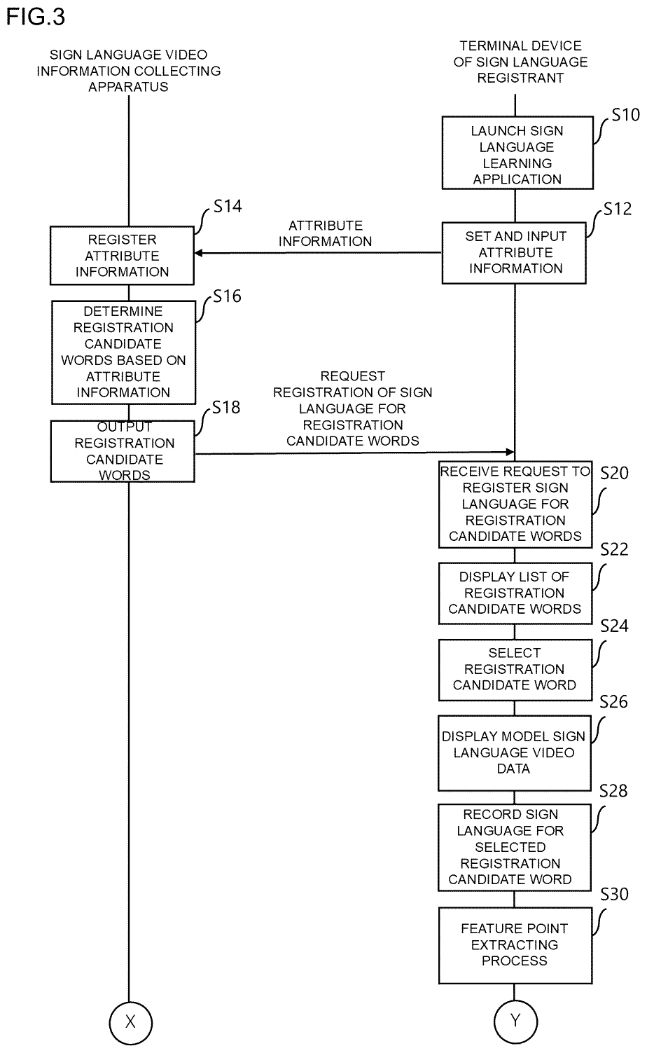

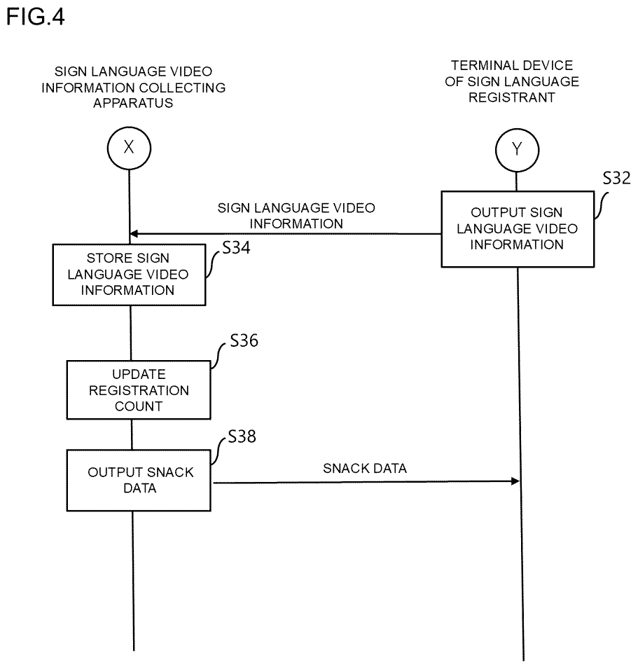

Next, the flow of processes performed by the sign language video information collecting system 1 in this form will be described with reference to the flow charts illustrated in FIG. 3 and FIG. 4.

First, a sign language registrant launches the sign language learning application using the terminal device 20 (S10). In the case that the sign language registrant is using the sign language learning application for the first time, attribute information of the sign language registrant is set and entered on the terminal device 20 (S12).

The attribute information which is set and input at the terminal device 20 is obtained by the attribute information obtaining unit 11 of the sign language video information collecting apparatus 10 from the terminal device 20 and registered (S14). If the sign language registrant has used the sign language learning application in the past and the attribute information of the sign language registrant has already been registered, the attribute information obtaining unit 11 reads out the registered attribute information of the sign language registrant based on the identification information of the terminal device 20.

Then, the registration candidate word determining unit 12 of the sign language video information collecting apparatus 10 determines registration candidate words which the sign language registrant is requested to register sign language for based on the attribute information of the sign language registrant, employing the registration count per attribute table and the registration count per registrant table (S16). The sign language video information collecting apparatus 10 outputs the registration candidate words to the terminal device 20 (S18).

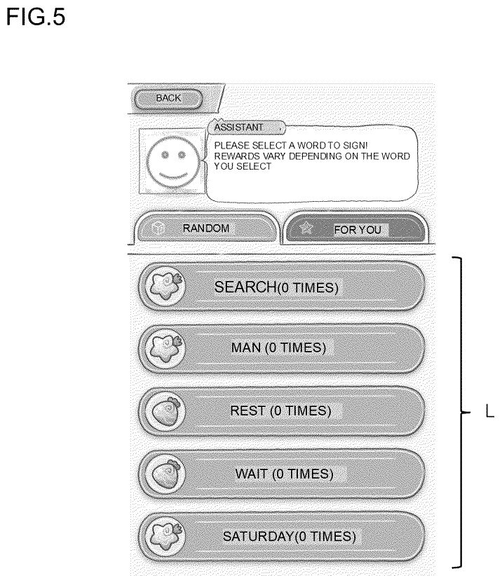

The terminal device 20 receives the sign language registration request and registration candidate words which are output from the sign language video information collecting apparatus 10 (S20). Next, the terminal device 20 displays a list of the received registration candidate words on the display unit 22 (range L illustrated in FIG. 5) (S22). The sign language registrant selects the registration candidate word that he/she wishes to learn from the plurality of registration candidate words displayed on the display unit 22 of the terminal device 20 (S24).

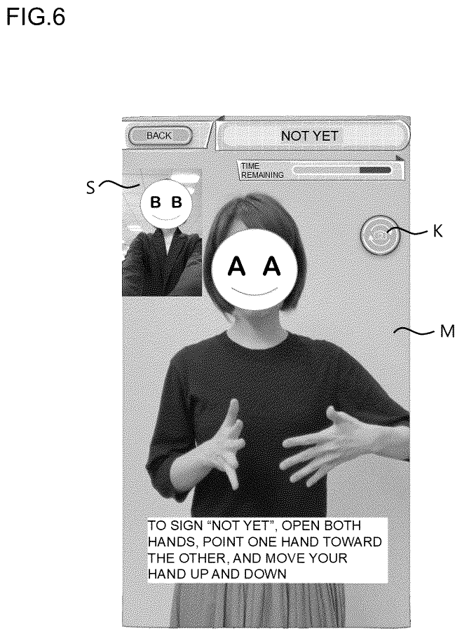

When a certain registration candidate word is selected by the sign language registrant, the control unit 21 of the terminal device 20 reads the model sign language video data corresponding to the registration candidate word from the storage unit 23 and displays the model sign language video data on the display unit 22, as illustrated in FIG. 6 (S26).

Then, the sign language registrant demonstrates the sign language of the selected registration candidate word while watching the model sign language video data displayed on the display 22, and the demonstration is recorded by the recording unit 25 (S28). At this time, the sign language video data of the model may be displayed on a main screen M while the imaged data of the sign language registrant is displayed on a thumbnail screen S behind it, as illustrated in FIG. 6. Further, the display of the main screen M and the thumbnail screen S may be interchanged by selecting a switch button K.

Then, the control unit 21 administers the feature point extraction process on the sign language video data which is recorded by the recording unit 25 to extract feature points (S30), and obtains the feature points as sign language video information. The control unit 21 outputs the obtained sign language video information to the sign language video information collecting apparatus 10 (S32).

The sign language video information which is output from the terminal device 20 is obtained by the sign language video information obtaining unit 13 together with registration candidate word information (registration words), and the registration candidate words (registration words) and the sign language video information are correlated and stored in the storage unit 14 (S34). At this time, the number of registrations in the registration count per attribute table and the registration count per registrant table are updated based on the stored registration candidate words and the attribute information of the sign language registrant (S36).

Further, the reward data output unit 15 of the sign language video information collecting apparatus 10 outputs information regarding pet snacks to be used in the pet raising game to the terminal device 20 as reward data (S38). The terminal device 20 stores the received snack data and makes it available for use when the pet raising game is launched.

According to the sign language video information collecting system 1 of the above embodiment, the attribute information of the sign language registrant is obtained, the registration candidate words for which sign language registration is requested are determined based on the attribute information of the sign language registrant, and the determined registration candidate words are output to the terminal device of the sign language registrant. That is, the sign language video data collecting apparatus 10, not the sign language registrant, determines the registration candidate words. Then, the sign language video information corresponding to the registration candidate words output from the terminal device 20 of the sign language registrant is obtained in response to the input of the registration candidate words, and the obtained sign language video information is stored, such that sign language video data can be collected from many people in an even and unbiased manner in the number of registrations for each registration word.

In addition, according to the sign language video information collecting system 1 of the above embodiment, the registration candidate words are determined based on the attribute information of the sign language registrant. Therefore, it is possible to collect sign language video data in an even and unbiased manner in the number of registrations with respect to the attributes of the sign language registrants.

Further, in the sign language video information collecting system 1 of the above embodiment, the number of registration words with a relatively small number of registrations is determined as registration candidate words by referring to the registration count per attribute table and the registration count per registrant table based on the attribute information of the sign language registrants. Therefore, the registration words with a small number of registrations can be determined as registration candidate words by a simple process.

Still further, in the sign language video information collecting system 1 of the above embodiment, the attribute information of the sign language registrant includes at least one of the following: the registrant's identification information, gender, age, hometown, occupation information, physique information, and sign language speed information. Therefore, sign language video information of people with various attributes can be collected.

Still yet further, the sign language video information collecting system 1 of the above embodiment obtains information regarding feature points of sign language movements which are extracted from sign language videos as sign language video information. That is, information regarding feature points of sign language movements is output from the terminal device 20 to the sign language video information collecting apparatus 10. Therefore, the amount of data transmission can be reduced. In addition, since the sign language video data itself is not output, the privacy of the sign language registrants can be protected.

Alternatively, the sign language video data itself may be output from the terminal device 20 to the sign language video information collecting apparatus 10 as the sign language video information. In this case, a feature point extraction process may be administered on the sign language video data by the sign language video information collecting apparatus 10.

In addition, in the sign language video information collecting system 1 of the above embodiment, when the sign language video information which is output from the terminal device 20 of the sign language registrant is obtained, outputs snack data as reward data to the terminal device 20 of the sign language registrant. Therefore, the sign language registrants can use the snack data in a pet raising game and learn sign language while enjoying themselves. This feature motivates the sign language registrants to continue learning the sign language. In addition, in terms of collecting sign language video information, sign language registrants can be encouraged to take sign language videos and output sign language video information.

The reward data which is output from the sign language video information collecting apparatus 10 to the terminal device 20 is not limited to being snack data to be used in pet raising games as in the above embodiment. The reward data may alternatively include points that may be used for shopping on e-commerce sites, miles that may be used with airline companies, etc.

Here, in the sign language video information collecting system 1 of the above embodiment, the party who collects the sign language video data requests the sign language registrant to register candidate words to be registered, and the sign language video data is collected. However, there is a possibility that the candidate words which are requested by the party collecting the sign language video data are words for advanced sign language users, words for which hand movements are difficult, or words that are not used very often. In such cases, it may be difficult for the sign language registrant to be motivated to send sign language movement data for such word candidates, making it difficult to collect desired sign language video data.

A sign language video information collecting system 2 of a second embodiment of the sign language video information collecting apparatus, which is capable of motivating the registration of sign language video data and collect sign language video data from many people in an even and unbiased manner will be described below. In the following description, descriptions of components which are the same as those of the sign language video information collecting system 1 of the first embodiment described above will be omitted.

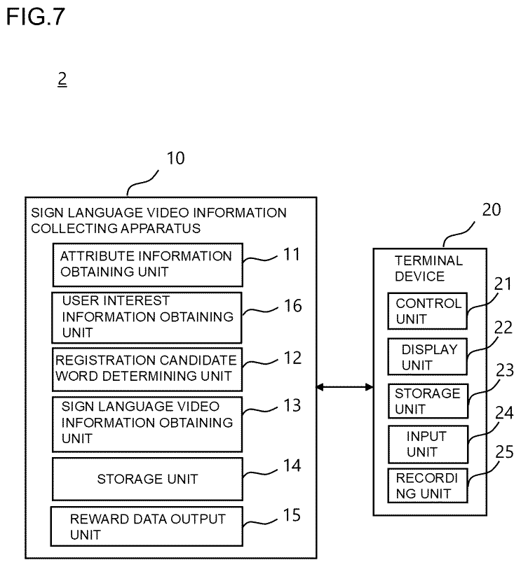

FIG. 7 is a block diagram that illustrate the schematic structure of the sign language video information collecting system 2 of the second embodiment.

As illustrated in FIG. 7, a sign language video information collecting apparatus 10 is equipped with an attribute information obtaining unit 11, a user interest information obtaining unit 16, a registration candidate word determining unit 12, a sign language video information obtaining unit 13, a storage unit 14, and a reward data output unit 15.

The attribute information obtaining unit 11 obtains attribute information of sign language registrants (hereinafter referred to as “user attribute information” in the present embodiment). The user attribute information is information related to the sign language registrant as described above, and includes, for example, at least one of the following: identification information unique to the sign language registrant, gender, age, hometown, occupation information (including information indicating that registrants are students), the registrant's purpose for learning sign language, physique information, and sign language speed information.

The user interest information obtaining unit 16 obtains user interest information that indicates a range to which the words in which the sign language registrant is interested belong. Specifically, the user interest information obtaining unit 16 obtains category information and level information as user interest information.

Category information is a predefined range of registration words based on similarity among words. Specifically, a “weather” category is set as a range to which registration words such as “rain”, “sunny”, and “cloudy” belong, for example. A “greetings” category is set as a range to which registration words such as “hello,” “good evening,” and “good morning” belong, for example, belong. A “people/family” category is set as a range to which registration words such as “father”, “mother”, “friend”, and “romantic partner” belong. Other categories such as “colors” and “directions” are also set.

The level information is a predefined range of words based on the difficulty level of words when they are expressed in sign language. In the present embodiment, the level information is set based on the sign language proficiency test level. The sign language proficiency test level is a level of difficulty in the sign language proficiency test for testing the proficiency of use of sign language as a language. The sign language proficiency test is a test for determining the proficiency level of sign language provided by the NPO Sign Language Proficiency Test Association.

There are levels 1 through 7 for the sign language proficiency test, and each level includes its own target words. Level 6 includes about 100 words and level 5 includes about 200 words, for example. Levels 5, 6, and 7 are beginner level, levels 3 and 4 are intermediate, and levels 1 and 2 are advanced.

The level information is preset as units of levels or as beginner, intermediate, and advanced levels.

The user attribute information obtained by the attribute information obtaining unit 11 and the user interest information obtained by the user interest information obtaining unit 16 are set and input at a terminal device 20 of a sign language registrant and output from the terminal device 20 to the sign language video information collecting apparatus 10.

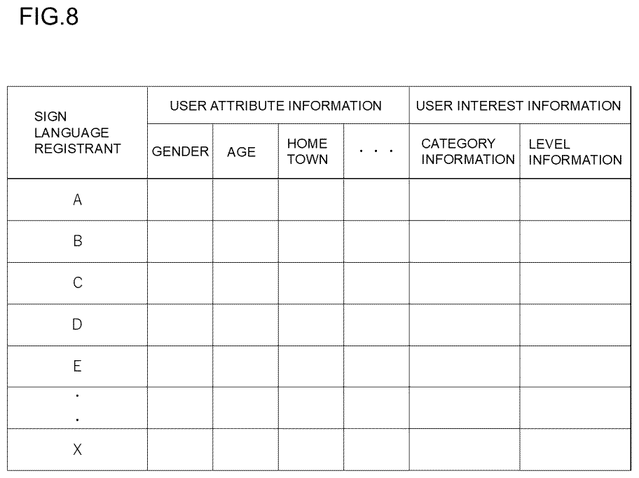

The sign language video information collecting apparatus 10 stores the entered user attribute information and user interest information in the storage unit 14 by correlating them with the identification information of each sign language registrant. FIG. 8 illustrates an example of a user information table in which user attribute information and user interest information are correlated and stored for each of sign language registrants A through X. The user information table illustrated in FIG. 8 is stored in the storage unit 14.

The registration candidate word determining unit 12 determines registration candidate words for which a sign language registrant is requested to register sign language, based on the user attribute information and user interest information described above. Then, the registration candidate word determining unit 12 outputs the determined registration candidate words to the terminal device 20 of the sign language registrant.

The following is a detailed explanation of the method by which the registration candidate word determining unit 12 determines registration candidate words. The basic flow of the method of determining registration candidate words in the present embodiment will be described. First, the registration candidate word determining unit 12 determines the insufficient registration words with small numbers of registrations, and then determines words from among the insufficient registration words that the user appears to be interested in and that the user has not yet learned as registration candidate words, based on the user attribute information. The method for determining the insufficient registration words based on user attribute information is the same as the method for determining registration candidate words that employs the registration count per attribute table illustrated in FIG. 2A and the registration count per registrant table illustrated in FIG. 2B described in connection with the first embodiment above.

That is, the registration candidate word determining unit 12 determines the insufficient registration words using the registration count per attribute table illustrated in FIG. 2A. In addition, the registration candidate word determining unit 12 determines unlearned words which have not yet been learned by the sign language registrant using the registration count per registrant table illustrated in FIG. 2B. In the first embodiment above, registration words with zero registrations are defined as unlearned registration words, but the threshold value is not limited to zero. The threshold value may be set to 3 or more, registration words having three or more registrations may be judged to be learned registration words, and registration words having two or fewer registrations may be determined to be unlearned registration words Next, the registration candidate word determining unit 12 determines registration words that the user is likely to show interest in as registration candidate words from among the insufficient registration words which are determined in the manner described above, based on the user interest information.

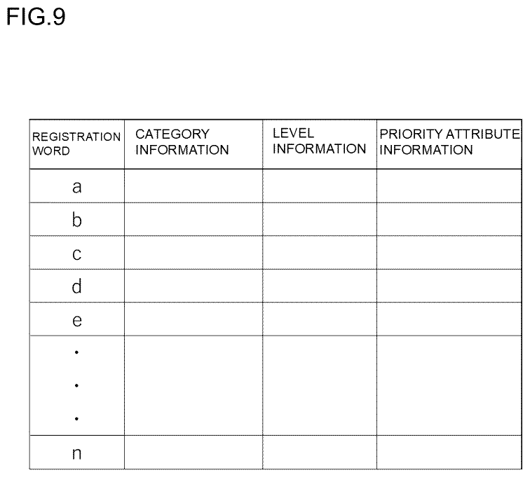

First, as a prerequisite, the registration candidate word determining unit 12 stores a registration word information table in which category information, level information, and priority attribute information are set for all of the registration words in advance, respectively. FIG. 9 illustrates an example of a registration word information table. The category and level information which are set for each registration word correspond to the category and level information included in the user interest information described above. Meanwhile, the priority attribute information which is set for each registration word is information set in advance by the party collecting the sign language video information for each registration word, and is the user attribute information that indicates that a sign language registrant is expected to show interest in certain types of words.

Based on the user interest information specified by the sign language registrant, the registration candidate word determining unit 12 identifies the registration words that the sign language registrant may show interest in by referring to the registration word information table illustrated in FIG. 9, and determines them as registration candidate words.

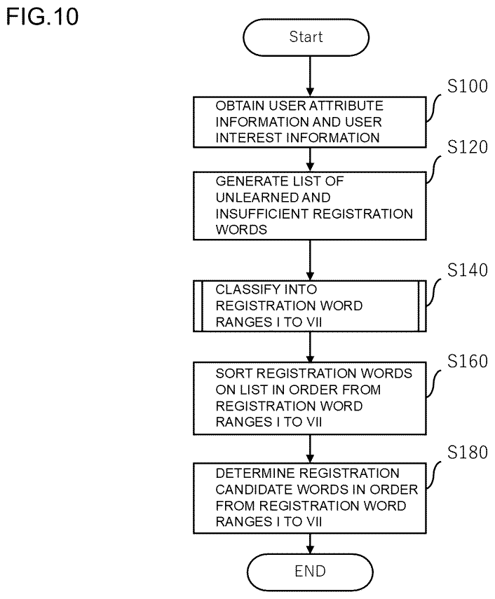

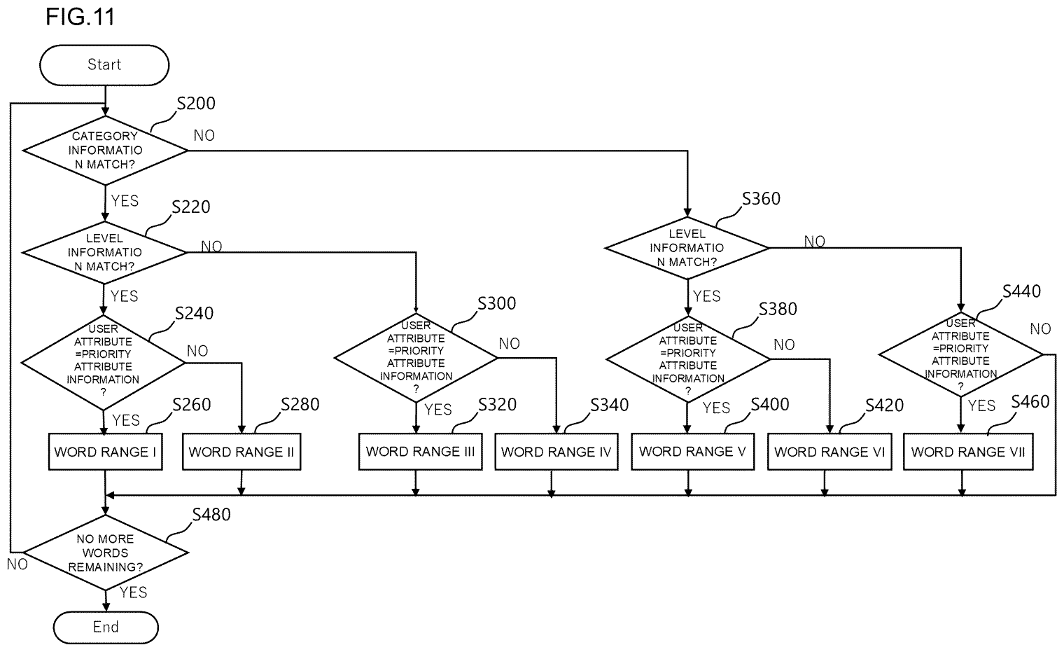

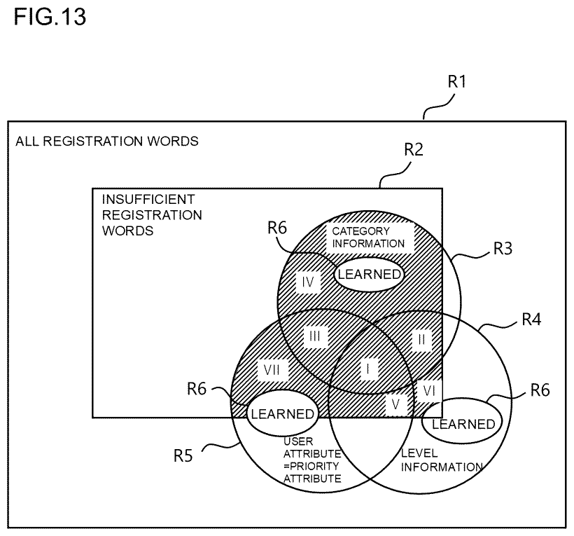

FIG. 10 and FIG. 11 are flow charts for explaining the method of determining registration candidate words based on the user interest information. FIG. 13 schematically illustrates the relationship among a range R1 of all registration words, a range R2 of insufficient registration words, ranges R3 and R4 of registration words that belong in user interest information, and a range R5 of registration words of priority attribute information that includes user attribute information of the sign language registrant, which are set in the registration candidate word determining unit 12 in advance.

The range R3 indicates a range of registration words that belong to the category information specified by the sign language registrant in the user interest information, and range R4 shows the range of registration words that belong to the level information specified by the sign language registrant in the user interest information. In addition, in FIG. 13, a range R6 indicates a range of registration words that have already been learned by the sign language registrant.

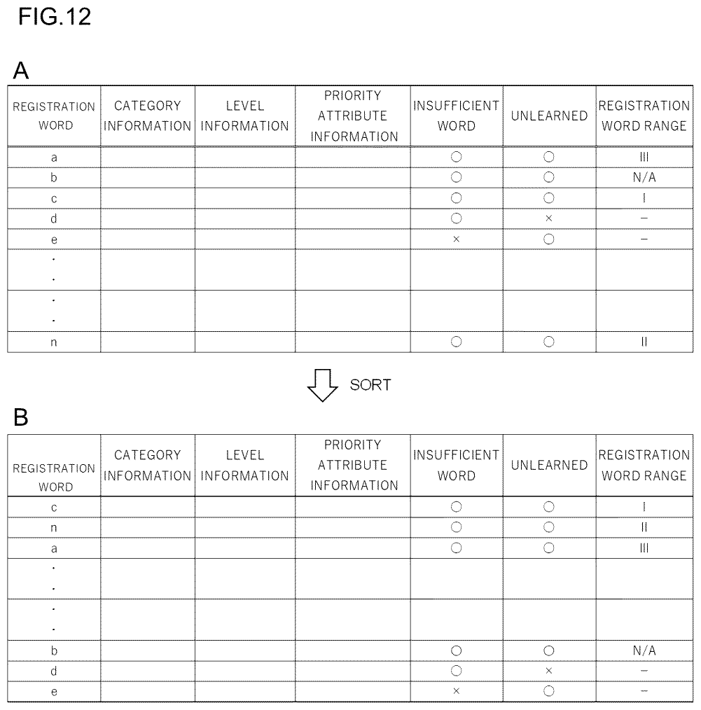

The following is a detailed description with reference to the flow charts illustrated in FIG. 10 and FIG. 11, the list illustrated in FIG. 12, and the Venn diagram illustrated in FIG. 13. In the present embodiment, there are three types of attributes, which are the category information, the level information, and the user attribute information as described above. Registration candidate words are determined in order of priority from the category information, the level information, and the user attribute information. In addition, the numbers I through VII in FIG. 13 indicate higher priority for smaller numbers.

As illustrated in the flow chart of FIG. 10, the registration candidate word determining unit 12 first obtains the user attribute information and the user interest information of a sign language registrant (S100). The registration candidate word determining unit 12 confirms whether there are words which are unlearned by the sign language registrant and whether these words are insufficient registration words with respect to all registration words x based on the user attribute information and the user interest information of the sign language registrant, and creates a list of unlearned and insufficient registration words (S120).

Next, the registration candidate word determining unit 12 determines to which range of registration word ranges I to VII in the Venn diagram shown in FIG. 12 the unlearned and insufficient registration words in the list belong (S140). FIG. 11 is a flow chart that illustrates the process for determining the range of registration word.

As illustrated in FIG. 11, the registration candidate word determining unit 12 first checks whether the category information of a registration word matches the category information of the user interest information (S200).

If the category information matches (S200, YES), the registration candidate word determining unit 12 checks whether the level information of the registration word matches the level information of the user interest information (S220). If the level information matches (S220, YES), the registration candidate word determining unit 12 checks whether the user attribute information of the sign language registrant is included in the priority attribute information of the registration word (S240). If the user attribute information of the sign language registrant is included in the priority attribute information of the registration word (S240, YES), the registration word is determined to belong to the registration word range I (S260).

In the case that the user attribute information of the sign language registrant is not included in the preferred attribute information of the registration word at S240 (S240, NO), the registration word is determined to belong to the registration word range II (S280).

In the case that it is judged that the level information does not match at S220 (S220, NO), the registration candidate word determining unit 12 checks whether the user attribute information of the sign language registrant is included in the priority attribute information of the registration word (S300). In the case that the user attribute information of the sign language registrant is included in the priority attribute information of the registration word, the registration word is judged to belong to the registration word range III (S320). In the case that the user attribute information of the sign language registrant is not included in the priority attribute information of the registration word, the registration word is judged to belong to the registration word range IV (S340).

In the case that the category information does not match in S200 (S200, NO), the registration candidate word determining unit 12 checks whether the level information matches (S360). In the case that the level information matches (S360, YES), the registration candidate word determining unit 12 checks whether the user attribute information of the sign language registrant is included in the priority attribute information of the registration word (S380). In the case that the user attribute information of the sign language registrant is included in the priority attribute information of the registration word (S380, YES), the registration word belongs to the registration word range V (S400), and if not (S380, NO), the registration word is judged to belong to the registration word range VI (S420).

If the level information does not match at S360 (S360, NO), the registration candidate word determining unit 12 checks whether the user attribute information of the sign language registrant is included in the priority attribute information of the registration word (S440). In the case that the user attribute information of the sign language registrant is included in the priority attribute information of the registration word (S440, YES), the registration word is judged as belonging to the registration word range VII (S460), and if not (S440, NO), the registration word is judged as not belonging to any of the ranges I to VII.

The processes from S200 to S460 is repeated until there are no more unlearned and insufficient registration words which are targets of the judging process (S480, NO), and the process is completed when all unlearned and insufficient words have been judged (S480, YES).

Returning to the flow chart illustrated in FIG. 10, the registration candidate word determining unit 12 sorts the list of unlearned and insufficient registration words such that they are in the order of registration word ranges I-VII (S160). FIG. 12A illustrates the list before sorting, and FIG. 12B illustrates the list after sorting. In the lists illustrated in FIG. 12A and FIG. 12B, it is indicated whether a registration word is unlearned, whether the registration word is an insufficient registration word, and the registration word range among the ranges I through VII to which the registration word belongs for each of the registration words.

Then, the registration candidate word determining unit 12 refers to the sorted list illustrated in FIG. 12B and determines registration candidate words in order from the registration word range I to the registration word range VII (S180).

By determining the registration candidate words in the manner described above, the registration candidate word determining unit 12 determines registration words that are insufficient registration words and in which the sign language registrant is interested as registration candidate words. That is, the registration words belonging to the shaded range in the Venn diagram illustrated in FIG. 13 are determined as registration candidate words in order from the registration word range I to the registration word range VII. In the present embodiment, the three attributes (the category information, the level information, and the user attribute information) are employed to determine the registration candidate words, but the attributes are not limited to these, and other attributes may be used.

In the case that the number of registration words which are registration candidate words for a given sign language registrant becomes zero as a result of determining the registration candidate words according to the flow charts illustrated in FIG. 10 and FIG. 11, the range of category information and level information in the user interest information is increased by expanding the range of category information and level information in the Venn diagram illustrated in FIG. 13, that is, by expanding the ranges of R3 and R4 in the category information and the level information in the Venn diagram illustrated in FIG. 13. That is, by expanding the range of category information R3 and the range of level information R4 in FIG. 13, the number of registration words which are targets for candidate registration may be increased, and the registration candidate words may be determined again according to the flow charts illustrated in FIG. 10 and FIG. 11.

As a method of expanding the range of category information R3, for example, other category information (“greetings”, for example) may be added in addition to the category information which is included in the user interest information (“weather”, for example). As a method for determining the category information to be newly added, category information that is highly relevant to the category information which included in the user interest information may be determined as the newly added category information, for example.

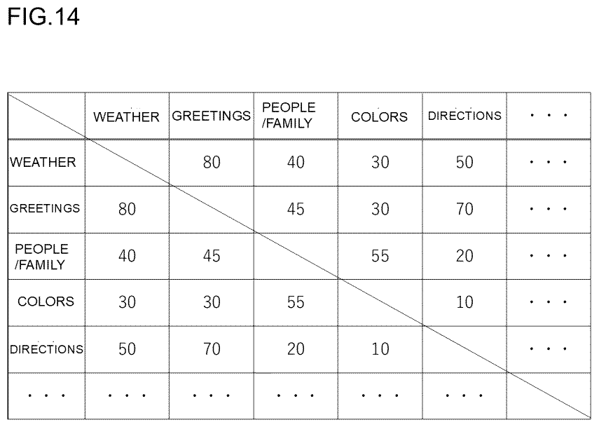

FIG. 14 illustrates an example of a category relevance table in which the relevance among category information is set in advance. The registration candidate word determining unit 12 refers to the category relevance table illustrated in FIG. 14 and determines which category information has the highest relevance to the category information of the user interest information as the category information to be newly added, giving priority to the category information that has the highest relevance, for example. In the case that the category information of the user interest information is “weather”, the category information with the highest relevance, “greetings”, is determined first as the category information to be newly added. Thereafter, “people/family”, “colors”, and “directions” are added in that order. Then, the registration candidate word determining unit 12 outputs the final registration candidate words which are determined in the manner described above to the terminal device 20 of the sign language registrant.

The sign language video information obtaining unit 13 obtains sign language video information corresponding to the registration candidate words output from the terminal device 20 of the sign language registrant in response to the input of the registration candidate words. In the present embodiment, the sign language registrant demonstrates the sign language corresponding to the registration candidate word using the terminal device 20 and records the demonstration. The terminal device 20 extracts feature points of the sign language movements from the video data of the recorded sign language and outputs information regarding the feature points as sign language video information to the sign language video information collecting apparatus 10. The sign language video information obtaining unit 13 then obtains the sign language video information which is output from the terminal device 20 in the manner described above.

The storage unit 14 stores sign language video information corresponding to the registration candidate words which are obtained by the sign language video information obtaining unit 13 correlated with the registration candidate words. At this time, the number of registrations in the registration count per attribute table and the number of registrations per registrant table are updated based on the stored registration candidate words and the attribute information of the sign language registrant. In the present embodiment, the storage unit 14 corresponds to the sign language video information storage unit of the present disclosure.

The reward data output unit 15 is the same as that of the first embodiment described above.

The terminal device 20 of the sign language registrant is also the same as that of the first embodiment described above.

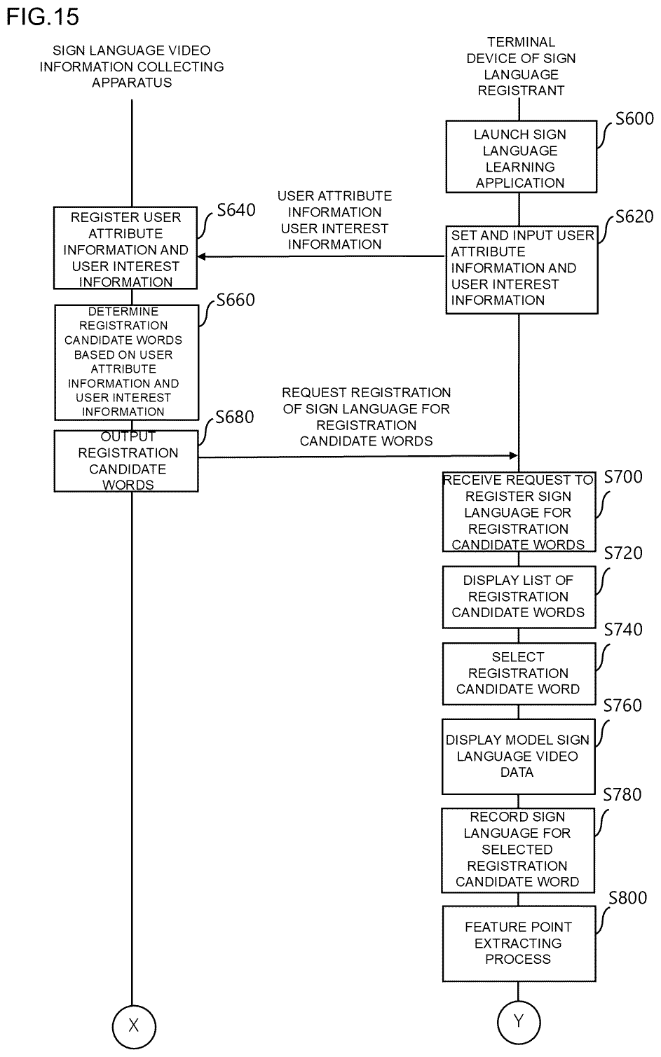

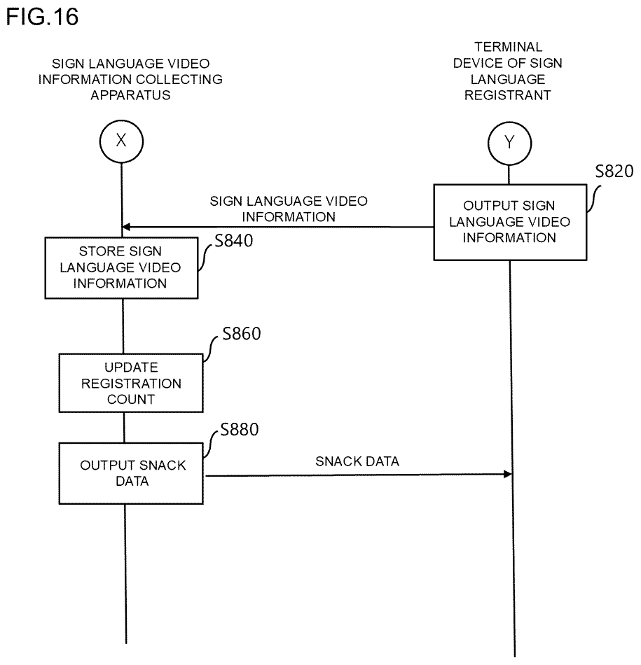

Next, the flow of processes of the sign language video information collecting system 2 of the second embodiment will be described with reference to the flow charts illustrated in FIG. 15 and FIG. 16.

First, a sign language registrant launches the sign language learning application using the terminal device 20 (S600). In the case that the sign language registrant is using the sign language learning application for the first time, attribute information and the user interest information of the sign language registrant are set and entered at the terminal device 20 (S620).

The user attribute information and the user interest information which are set and input at the terminal device 20 are obtained by the attribute information obtaining unit 11 and the user interest information obtaining unit 16 of the sign language video information collecting apparatus 10 from the terminal device 20 and are registered in correlation with the identification information of the sign language registrant (S640). In the case that the sign language registrant has used the sign language learning application in the past and the attribute information of the sign language registrant has already been registered, the attribute information obtaining unit 11 reads out the registered user attribute information and the user interest information of the sign language registrant based on the identification information of the terminal device 20.

Then, the registration candidate word determining unit 12 of the sign language video information collecting apparatus 10 determines registration candidate words which the sign language registrant is requested to register sign language for based on the user attribute information and the user interest information of the sign language registrant in the manner described above (S660). The sign language video information collecting apparatus 10 outputs the registration candidate words to the terminal device 20 (S680).

The terminal device 20 receives the sign language registration request and registration candidate words which are output from the sign language video information collecting apparatus 10 (S700). Next, the terminal device 20 displays a list of the received registration candidate words on the display unit 22 (the range L illustrated in FIG. 5), as illustrated in FIG. 5 (S22). The sign language registrant selects the registration candidate word that he or she wishes to learn from among the plurality of registration candidate words displayed on the display unit 22 of the terminal device 20 (S740).

When a certain registration candidate word is selected by the sign language registrant, the control unit 21 of the terminal device 20 reads out the model sign language video data corresponding to the registration candidate word from the storage unit 23 and displays the model sign language video data on the display unit 22, as illustrated in FIG. 13 (S760).

Then, the sign language registrant demonstrates the sign language of the selected registration candidate word while watching the model sign language video data displayed on the display 22, and the demonstration is recorded by the recording unit 25 (S28). At this time, the sign language video data of the model may be displayed on a main screen M while the imaged data of the sign language registrant is displayed on a thumbnail screen S behind it, as illustrated in FIG. 6. Further, the display of the main screen M and the thumbnail screen S may be interchanged by selecting a switch button K.

Then, the control unit 21 administers the feature point extraction process on the sign language video data which is recorded by the recording unit 25 to extract feature points (S800), and obtains the feature points as sign language video information. The control unit 21 outputs the obtained sign language video information to the sign language video information collecting apparatus 10 (S820).

The sign language video information which is output from the terminal device 20 is obtained by the sign language video information obtaining unit 13 together with registration candidate word information (registration words), and the registration candidate words (registration words) and the sign language video information are correlated and stored in the storage unit 14 (S840). At this time, the number of registrations in the registration count per attribute table and the registration count per registrant table are updated based on the stored registration candidate words and the user attribute information of the sign language registrant (S860).

Further, the reward data output unit 15 of the sign language video information collecting apparatus 10 outputs information regarding pet snacks to be used in the pet raising game to the terminal device 20 as reward data (S880). The terminal device 20 stores the received snack data and makes it available for use when the pet raising game is launched.

Note that in the sign language video information collecting system 1 of the present embodiment, the registration candidate words which are determined according to the flow charts illustrated in FIG. 10 and FIG. 11 are displayed in a list when the “random” tag illustrated in FIG. 5 is selected. Other tags such as “category”, “level”, “child”, and “female” may be provided, and a different list of registration candidate words may be displayed for each tag. In the case that the “category” tag is selected, a list of unlearned and insufficient registration words that belong to the category information of the user interest information may be displayed, for example. As another example, in the case that the “level” tag is selected, a list of unlearned and insufficient registration words that belong to the level information in the user interest information may be displayed. In the case that the “child” tag is selected, registration words that include the age of a child in the priority attribute information may be selected and displayed in the list. In the case that the “female” tag is selected, registration words that include female as the gender in the priority attribute information may be selected and displayed in the list.

According to the sign language video information collecting system 2 of the second embodiment above, the system obtains user interest information of the sign language registrant, determines registration candidate words to request registration of sign language by the sign language registrant based on the user interest information, and outputs the determined registration candidate words to the terminal device 20 of the sign language registrant. Then, in response to the input of the candidate registration word, the sign language video information corresponding to the candidate registration word output from the terminal device 20 of the sign language registrant is obtained, and the obtained sign language video information is stored. Therefore, the sign language registrant can be motivated to register the sign language video information. In addition, sign language video data information can be registered by many people in an even and unbiased manner in the number of registrations for each registration word. That is, the sign language video information collecting system 2 of the second embodiment exhibits the effect of preventing bias in the number of registrations due to the fact that sending registration candidate words that are out of the interest of the sign language registrants will reduce their motivation and prevent them from registering the sign language video information.

In addition, in the sign language video information collecting system 2 of the second embodiment above, the category information specified by the sign language registrant is employed to determine the registration candidate words, such that the registrant can determine the registration candidate words that belong to the category information in which he or she is interested, thereby motivating him or her to register the sign language video information.

Further, the sign language video information collecting system 2 of the second embodiment above employs the level information specified by the sign language registrant to determine the registration candidate words. Therefore, it is possible to determine the registration candidate words that match the level of sign language proficiency of the sign language registrant, thereby motivating the sign language registrant to register sign language video information.

Still further, in the sign language video information collecting system 2 of the second embodiment above, the registration candidate words are determined based on the priority attribute information of the registration words. Therefore, more interest can be generated for the registration candidate words and motivate sign language registrants to register sign language video information. Even in the case that a user does not input interest information, the effect that determining registration candidate words in which the user is more interested in the user attribute information becomes possible is exhibited.

Still yet further, the sign language video information collecting system 2 of the above second embodiment refers to the registration count per attribute table based on the attribute information of the sign language registrant, and determines registration words with relatively small registration counts as registration candidate words. This makes it possible to determine registration candidate words having lower registration counts by a simple process. Thereby, it becomes possible to collect sign language video data in an even and unbiased manner.

In the sign language video information collecting systems 1 and 2 of the first and second embodiments above, an application for learning a sign language is provided to the sign language registrant. In the application, the party collecting the sign language video data presents candidates for words to be registered to the sign language registrant. The sign language registrant then records and registers the sign language video data for these words, thereby ensuring that the sign language video data is collected in an even and unbiased manner.

However, although the application can enable learn of sign language words one by one, the effect of learning sign language, that is, the ability to converse in sign language, may not be realized. Therefore, the sign language registrant's motivation to learn may decrease, and the collection of sign language video data employing the above application may become difficult.

A sign language video information collecting system 3 of a third embodiment that employs an embodiment of a sign language information generating apparatus, which can motivate the registration of sign language video data and collect sign language video data from many people in an even and unbiased manner will be described below. Note that in the following description, descriptions of components which are the same as those of the sign language video information collecting systems 1 and 2 of the first and second embodiments described above will be omitted.

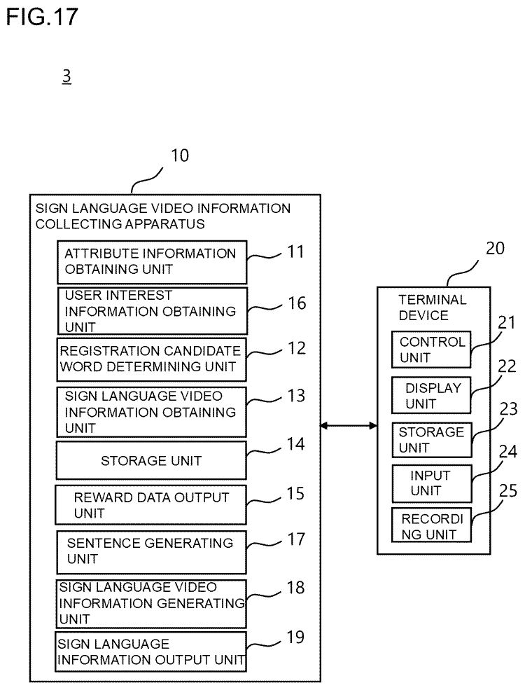

FIG. 17 is a block diagram that illustrates the schematic configuration of the sign language video information collecting system 3 of the third embodiment.

As illustrated in FIG. 17, the sign language video information collecting system 3 is equipped with a sign language video information collecting apparatus 10 and a terminal device 20 of a sign language registrant.

As illustrated in FIG. 17, the sign language video information collecting apparatus 10 is equipped with an attribute information obtaining unit 11, a user interest information obtaining unit 16, a registration candidate word determining unit 12, a sign language video information obtaining unit 13, a storage unit 14, a reward data output unit 15, a sentence generating unit 17, a sign language video information generating unit 18, and a sign language information output unit 19.

The functions of the attribute information obtaining unit 11, the user interest information obtaining unit 16, the registration candidate word determining unit 12, the sign language video information obtaining unit 13, the storage unit 14, and the reward data output unit 15 are the same as those of the sign language video information collecting system 2 of the second embodiment described above.

The sentence generating unit 17 identifies a plurality of registration words for which sign language video information has been registered by a given sign language registrant from among all registration words, and generates sentences using the identified plurality of registration words. Specifically, the sentence generating unit 17 refers to the registration count per registrant table illustrated in FIG. 2B, identifies registration words having registration counts of one or more, and generates sentences employing such registration words.

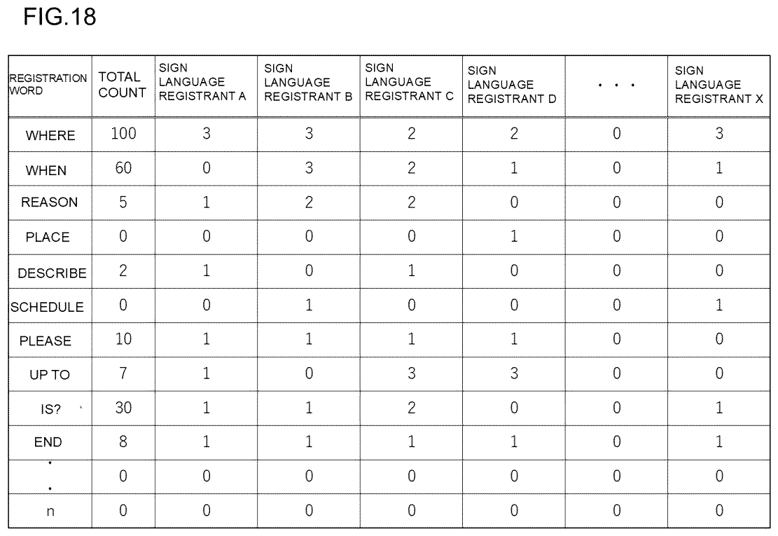

FIG. 18 is a table in which each of registration word a through n in the registration count per registrant table illustrated in FIG. 2b is replaced with an example of a specific registration word. In the registration count per registrant table illustrated in FIG. 18, “where”, “when”, “reason”, “place”, “describe”, “schedule”, “request”, “up to”, “is?”, and “end” are set as registration words in advance. For example, for sign language registrant A, the number of registrations for “where” is 3, and the registration counts for “reason”, “describe”, “request”, “up to”, “is?” and “end” are 1. According to the registration count per registrant table illustrated in FIG. 18, these words which are already registered are the registration words that have been learned by the sign language registrant A. The registration counts of other registration words are zero, and these registration words have not been learned by the sign language registrant A.

The sentence generating unit 17 refers to the registration count per registrant table illustrated in FIG. 18, identifies learned registration words, and generates sentences using some or all of the identified registration words. Specifically, the sentence generating unit 17 generates sentences by inputting the learned registration words of the sign language registrant A to a document generating AI (Artificial Intelligence). If there are many learned registration words, the sentence is generated by selecting a sufficient number of words (about 5 to 20 words) to make the length of the sentence moderate enough for the sign language registrant to demonstrate the sign language. Examples of sentences generated by the sentence generating unit 17 include “Where are you up to?” and “Please describe the reason”, for example. For example, AI that performs natural language processing such as ChatGPT (registered trademark), Microsoft 365 Copilot, and Gemini may be employed as the document generating AI. However, the present disclosure is not limited to these AI's, and other known technologies may be employed to generate sentences.

In addition, in the example above, sentences are generated employing registration words which have been learned by the sign language registrant. However, sentences may also be generated including unlearned registration words. Specifically, unlearned registration words which are related to learned registration words may be identified and included in a sentence, for example. Unlearned words that are related to learned words may be identified as words that belong to the same category information or the same level information as the learned words, but are unlearned words, for example. Alternatively, a table of highly related words may be employed to identify unlearned words that are related to learned words. Related unlearned registration words for a case in which “reason” has been learned and “describe” has not been learned, for example, because “reason” and “describe” are words that are often used together, such words are highly related registration words.

In addition, registration words that belong to the category information or the level information of the user interest information of the sign language registrant and have not yet been learned may be identified, and a predetermined number of registration words may be randomly selected from among these words and included in the sentence, for example.

In the present embodiment, the sentences are generated mainly from the learned registration words of the sign language registrant. However, the present disclosure is not limited to such a configuration, and sentences may also be generated mainly from unlearned registration words. A greater number of unregistered registration words than learned registration words may be input to the sentence generating AI to generate sentences, for example.

Next, the sign language video information generating unit 18 generates sign language video data that represent the sentences generated by the sentence generating unit 17. Specifically, the sign language video information generating unit 18 reads out model sign language video data that represent each registration word that constitutes the sentence generated by the sentence generating unit 17 from the storage unit 14, and generates sign language video data representing the sentence by joining these sign language video data together.

The sign language information output unit 19 outputs text data of each registration word that constitutes a sentence generated by the sentence generating unit 17 and the sign language video data that represents the sentence generated by the sign language video information generating unit 18 to the terminal device 20 of the sign language registrant.

An embodiment of the sign language video information collection program that includes a sign language information generating program is installed in the storage of the sign language video information collecting apparatus 10. When this sign language video information collection program is launched by the CPU, the functions of the components of the sign language video information collecting apparatus 10 described above are executed.

Next, the control unit 21 of the terminal device 20 of the present embodiment receives the sign language video information that represent a sentence output from the sign language video information collecting apparatus 10 and displays the sign language video on the display unit 22 based on the sign language video information.

The display unit 22 displays a list of registration candidate words, a sign language video of a model for a given registration candidate word, or a sign language video representing the sentence described above.

The other components of the terminal device 20 are the same as those of the first and second embodiments described above.

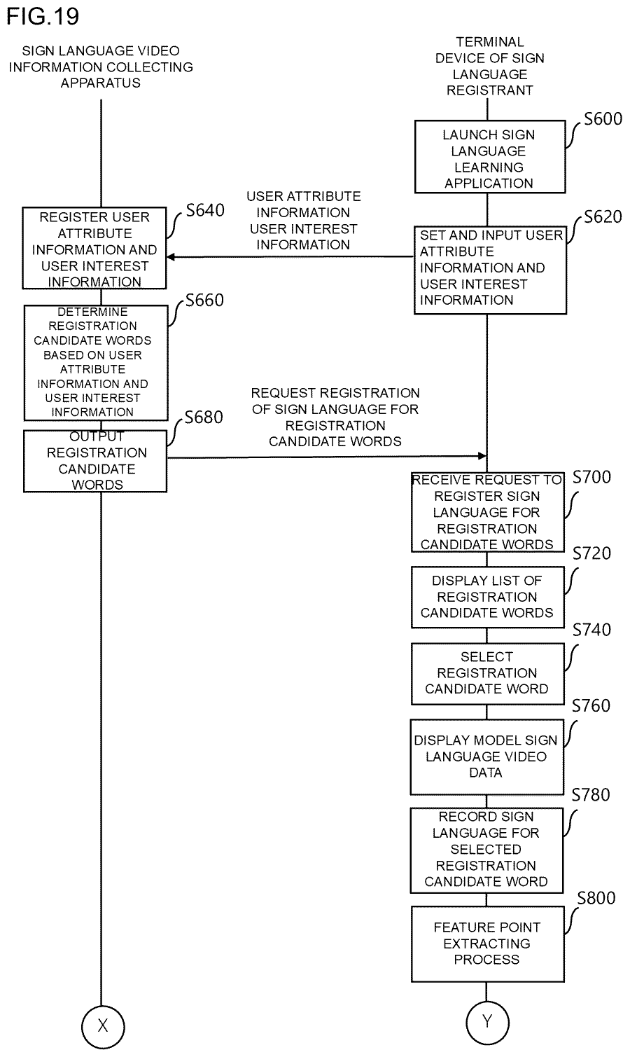

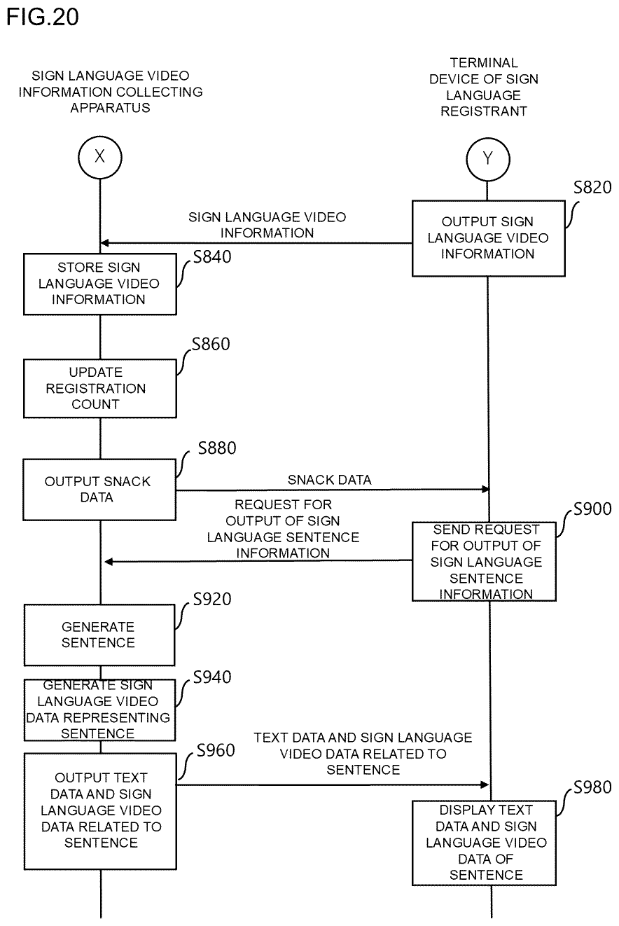

Next, the flow of processes of the sign language video information collecting system 3 of the present embodiment will be explained with reference to the flow charts illustrated in FIG. 19 and FIG. 20. The processes from S600 to S880 in the flow charts illustrated in FIG. 19 and FIG. 20 are the same as those of the sign language video information collecting system 2 of the second embodiment.

In the sign language video information collecting system 3 of the present embodiment, the sign language registrant sends a request for output of sign language sentence information to the sign language video information collecting apparatus 10 using the terminal device 20 in order to confirm the effect of learning sign language (S900).

The sign language video information collecting apparatus 10 generates a sentence employing the registration words that have been learned by the sign language registrant (S920) and generates sign language video data that represents the sentence (S940) in response to the request for output of the sign language sentence information. The generation of the sentence at S920 is performed as in the description of the sentence generating unit 17 above. Although a case in which learned registration words are employed is described here, unlearned registration words may also be included in the sentence.

Then, the sign language video information collecting apparatus 10 outputs text data of each registration word that constitutes the sentence generated in S920 and the sign language video data that represents the sentence to the terminal device 20 of the sign language registrant (S960). The terminal device 20 displays the text data of each input registration word and generates and displays a sign language video based on the sign language video data of the input sentence (S980). The display at S980 can be realized in the same manner as in S760 described above. As in the description of S780, the sign language registrant may also demonstrate the sign language of the text while watching the displayed model sign language video data, and record the demonstration.

Note that in the sign language video information collecting system 3 of the present embodiment, the sign language video information collecting apparatus 10 outputs the text data of each registration word that constitutes a sentence and the sign language video data representing the sentence to the terminal device 20. However, only one of these data may be output to the terminal device 20.

According to the sign language video information collecting system 3 of the third embodiment above, the system generates sentences using a plurality of registration words learned by the sign language registrant and outputs information regarding the generated sentences to the terminal device 20 of the sign language registrant, such that the sign language registrant can confirm the effect of learning sign language. That is, the sign language registrant can affirm the effect of being able to converse in sign language employing the learned registration words. Therefore, the sign language registrant's motivation to register sign language video information can be increased. This makes it possible to collect sign language video information from many people in an even and unbiased manner.

In addition, in the sign language video information collecting system 3 of the third embodiment above, the sign language video data that represents a sentence is generated, and the generated sign language video data is output to the terminal device 20 of the sign language registrant for display, such that the sign language registrant can not only learn sign language in units of registration words, but also sign language that represents the sentence.

Further, the sign language video information collecting system 3 of the third embodiment above generates sentences including registration words which have not been learned by the sign language registrant, which enables more variation in sentences and also enables the sign language registrant to learn the signs of the unlearned registration words.

Still further, in the sign language video information collecting system 3 of the third embodiment above, unlearned registration words related to learned registration words are employed as unlearned registration words, such that more appropriate sentences can be generated. Learning unlearned registration words related to learned registration words as sentences has the effect of providing an opportunity to learn new registration words and to utilize the newly learned registration words.

Still yet further, in the sign language video information collecting system 3 of the above third embodiment, registration words in which the sign language registrant shows interest are employed as unlearned registration words, which can further motivate the sign language registrant to learn.

Note that the present disclosure is not limited to the above embodiments, but may be realized by modifying the components to an extent that does not depart from the spirit thereof at the implementation stage. Also, various inventions may be formed by appropriate combinations of the plurality of components disclosed in the above embodiments. For example, all of the components described in the embodiments may be combined as appropriate. It is, of course, possible to make various modifications and applications within the scope that does not depart from the spirit of the disclosure.

The following items are further disclosed with respect to the present disclosure.

### (Item 1)

A sign language video information collecting apparatus of the present disclosure is equipped with a registration candidate word determining unit that determines registration candidate words for which a sign language registrant is requested to register sign language and outputs the determined registration candidate words to a terminal device of the sign language registrant, a sign language video information obtaining unit that obtains sign language video information corresponding to a registration candidate word which is output from the terminal device of the sign language registrant in response to input of the registration candidate words, and a sign language video information storage unit that stores sign language video information which is obtained by the sign language video information obtaining unit, correlated with the registration candidate word.

### (Item 2)

In the sign language video information collecting apparatus of Item 1, the registration candidate word determining unit may determine registration candidate words based on attribute information of the sign language registrant.

### (Item 3)

In the sign language video information collecting apparatus of Item 1 or Item 2, the registration candidate word determining unit may have a registration count table that manages the number of registrations of a given registration word, refer to the registration count table, and determine registration candidate words with low registration counts as the registration candidate words.

### (Item 4)

In the sign language video information collecting apparatus of Item 2, the registration candidate word determining unit may have a registration count table that manages the number of registrations for each attribute information of a given registration word, and the registration candidate word determining unit may refer to the registration count table based on the attribute information of the sign language registrant and determine registration candidate words with smaller registration counts as a registration candidate word.

### (Item 5)

In the sign language video information collecting apparatus of any one of Items 1 through 4, the sign language video information obtaining unit may obtain information regarding feature points of sign language movements extracted from a sign language video as the sign language video information.

### (Item 6)

The sign language video information collecting apparatus of any one of Items 1 through 5 may be equipped with a reward data output unit that outputs reward data to the terminal device of the sign language registrant when the sign language video information output from the terminal device of the sign language registrant is obtained.

### (Item 7)

The sign language video information collecting apparatus of any one of Items 1 through 6 may be equipped with a user interest information obtaining unit that obtains user interest information indicating a range to which words in which the sign language registrant shows interest belongs, the registration candidate word determining unit may determine registration candidate words to request the sign language registrant to register a sign language based on the user interest information, and the registration candidate words may be output to the terminal device of the sign language registrant.

### (Item 8)

In the sign language video information collecting apparatus of Item 7, the user interest information may include category information which is set in advance based on similarities among registration words.

### (Item 9)

In the sign language video information collecting apparatus of Item 7 or Item 8, the user interest information may include level information which is set in advance that indicates the degree of difficulty in expressing the registration words in sign language.

### (Item 10)

The sign language video information collecting apparatus of any one of Items 7 through 9 may be equipped with an attribute information obtaining unit that obtains user attribute information of the sign language registrant, and the registration candidate word determining unit may determine registration candidate words based on the user attribute information and priority attribute information set for each registration word.

### (Item 11)

In the sign language video information collecting apparatus of any one of Items 7 through 10, the registration candidate word determining unit may have a registration count table that manages the number of registrations for each registration word, and may determine registration words with small numbers of registrations as registration candidate words by referring to the registration count table.

### (Item 12)

In the sign language video information collecting apparatus of any one of Items 7 through 11, the sign language video information obtaining unit may obtain information regarding feature points of sign language movements extracted from a sign language video as the sign language video information.

### (Item 13)

The sign language video information collecting apparatus of any one of Items 7 to 12 may be equipped with a reward data output unit that outputs reward data to the terminal device of the sign language registrant when the sign language video information output from the terminal device of the sign language registrant is obtained.

### (Item 14)

A sign language video information collecting system of the present disclosure is equipped with the sign language video information collecting apparatus of any one of Items 1 through 13 and a terminal device of a sign language registrant.

### (Item 15)

A method for collecting sign language video information of the present disclosure determines registration candidate words for which a sign language registrant is requested to register sign language, outputs the determined registration candidate words to a terminal device of the sign language registrant, obtains sign language video information corresponding to a registration candidate word which is output from the terminal device of the sign language registrant in response to input of the registration candidate words, and stores the obtained sign language video information correlated with the registration candidate word.

### (Item 16)

In the method for collecting sign language video information of Item 15, user interest information indicating the range to which a word in which the sign language registrant shows interest belongs may be obtained, and registration candidate words for which sign language registration is requested to the sign language registrant may be determined based on the user interest information.

### (Item 17)

A program for collecting sign language video information of the present disclosure causes a computer to perform a step of determining registration candidate words for which a sign language registrant is requested to register sign language, a step of outputting the determined registration candidate words to a terminal device of the sign language registrant, a step of obtaining sign language video information corresponding to a registration candidate word which is output from the terminal device of the sign language registrant in response to input of the registration candidate words, and a step of storing the obtained sign language video information correlated with the registration candidate word.

### (Item 18)

The sign language video information collection program of Item 17 may cause the computer to perform a step of obtaining user interest information indicating the range to which a word in which the sign language registrant is interested belongs and a step of determining registration candidate words to request the sign language registrant to register sign language based on the user interest information.

### (Item 19)

A sign language information generating apparatus of the present disclosure is equipped with a sign language video information storage unit that stores sign language video information corresponding to a plurality of registration words, a sentence generating unit that generates a sentence using a portion or all of the plurality of registration words for which the sign language video information is stored by a sign language registrant, and a sign language information output unit that outputs information regarding the sentence generated by the sentence generation unit.

### (Item 20)

The sign language information generating apparatus according to Item 19 may be equipped with a sign language video information generating unit that generates sign language video information related to the sentence which is generated by the sentence generating unit, and the sign language information output unit may output the sign language video information generated by the sign language video information generating unit to the sign language registrant.

### (Item 21)

In the sign language information generating apparatus of Item 19 or 20, the sentence generating unit may generate a sentence that includes an unregistered registration word for which sign language video information by the sign language registrant has not been stored.

### (Item 22)

In the sign language information generating apparatus of Item 21, the sentence generating unit may identify a registration word which is related to registration words for which sign language video information has been stored as the unregistered registration word.

### (Item 23)

In the sign language information generating apparatus of Item 21 or 22, the sentence generating unit may identify registration words in which the sign language registrant shows interest as unregistered registration words.

### (Item 24)

A sign language information generating system of the present disclosure is equipped with a sign language information generating apparatus of any one of Items 19 through 23, and a terminal device that receives and displays information regarding a sentence which is generated by the sign language information generating apparatus.

### (Item 25)

A method of generating sign language information stores sign language video information corresponding to a plurality of registration words, generates a sentence employing a portion or all of the plurality of registration words for which the sign language video information is stored by a sign language registrant, and outputs information regarding the generated sentence.

### (Item 26)

A program for generating sign language video information causes a computer to execute a step of storing sign language video information corresponding to a plurality of registration words, a step of generating a sentence employing a portion or all of the plurality of registration words for which sign language video information has been stored by a sign language registrant; and a step of outputting information regarding the generated sentence.

What is claimed is:

1. A sign language video information collecting apparatus comprising:
a registration candidate word determining unit that determines registration candidate words for which a sign language registrant is requested to register sign language and outputs the determined registration candidate words to a terminal device of the sign language registrant;
a sign language video information obtaining unit that obtains sign language video information corresponding to a registration candidate word which is output from the terminal device of the sign language registrant in response to input of the registration candidate words; and
a sign language video information storage unit that stores sign language video information which is obtained by the sign language video information obtaining unit, correlated with the registration candidate word.

2. The sign language video information collecting apparatus as defined in claim 1, wherein:
the registration candidate word determining unit determines registration candidate words based on attribute information of the sign language registrant.

3. The sign language video information collecting apparatus as defined in claim 1, wherein:
the registration candidate word determining unit has a registration count table that manages the number of registrations of a given registration word, refers to the registration count table, and determine registration candidate words with smaller registration counts as the registration candidate words.

4. The sign language video information collecting apparatus as defined in claim 1, wherein:
the sign language video information obtaining unit obtains information regarding feature points of sign language movements extracted from a sign language video as the sign language video information.

5. The sign language video information collecting apparatus as defined in claim 1, further comprising:
a reward data output unit that outputs reward data to the terminal device of the sign language registrant when the sign language video information output from the terminal device of the sign language registrant is obtained.

6. The sign language video information collecting apparatus as defined in claim 1, further comprising:
a user interest information obtaining unit that obtains user interest information indicating a range to which words in which the sign language registrant shows interest belongs; wherein;
the registration candidate word determining unit determines registration candidate words to request the sign language registrant to register a sign language based on the user interest information; and
the registration candidate words are output to the terminal device of the sign language registrant.

7. A sign language video information collecting system comprising:
the sign language video information collecting apparatus as defined in claim 1; and
a terminal device of a sign language registrant.

8. A method for collecting sign language video information, comprising:
determining registration candidate words for which a sign language registrant is requested to register sign language;
outputting the determined registration candidate words to a terminal device of the sign language registrant;
obtaining sign language video information corresponding to a registration candidate word which is output from the terminal device of the sign language registrant in response to input of the registration candidate words; and
storing the obtained sign language video information correlated with the registration candidate word.

9. The method for collecting sign language video information as defined in claim 8, wherein:
user interest information indicating the range to which a word in which the sign language registrant shows interest belongs is obtained; and
registration candidate words for which sign language registration is requested to the sign language registrant are determined based on the user interest information.

10. A non-transitory computer-readable recording medium containing a program for collecting sign language video information that causes a computer to execute:
a step of determining registration candidate words for which a sign language registrant is requested to register sign language;
a step of outputting the determined registration candidate words to a terminal device of the sign language registrant;
a step of obtaining sign language video information corresponding to a registration candidate word which is output from the terminal device of the sign language registrant in response to input of the registration candidate words; and
a step of storing the obtained sign language video information correlated with the registration candidate word.

11. The program for collecting sign language video information as defined in claim 10, wherein:
the computer performs a step of obtaining user interest information indicating the range to which a word in which the sign language registrant is interested belongs; and
a step of determining registration candidate words to request the sign language registrant to register sign language based on the user interest information.

12. A sign language information generating apparatus comprising:
a sign language video information storage unit that stores sign language video information corresponding to a plurality of registration words;
a sentence generating unit that generates a sentence using a portion or all of the plurality of registration words for which the sign language video information is stored by a sign language registrant; and
a sign language information output unit that outputs information regarding the sentence generated by the sentence generation unit.

13. The sign language information generating apparatus as defined in claim 12, further comprising:
a sign language video information generating unit that generates sign language video information related to the sentence which is generated by the sentence generating unit; and wherein:
the sign language information output unit outputs the sign language video information generated by the sign language video information generating unit to the sign language registrant.

14. The sign language information generating apparatus as defined in claim 12, wherein:
the sentence generating unit generates a sentence that includes an unregistered registration word for which sign language video information by the sign language registrant has not been stored.

15. A sign language information generating system comprising:
a sign language information generating apparatus as defined in claim 12; and
a terminal device that receives and displays information regarding a sentence which is generated by the sign language information generating apparatus.

16. A method of generating sign language information as defined in claim 8, wherein:
generating a sentence employing a portion or all of the plurality of registration words for which the sign language video information is stored by the sign language registrant; and
outputting information regarding the generated sentence.

17. A non-transitory computer-readable recording medium containing a program for generating sign language video information that causes a computer to execute as defined in claim 10, wherein:
a step of generating a sentence employing a portion or all of the plurality of registration words for which the sign language video information has been stored by the sign language registrant; and
a step of outputting information regarding the generated sentence.
